(19) United States
(12) Patent Application Publication
(10) Pub. No.: US 2008/0109627 A1
(43) Pub. Date: May 8, 2008

(54) Nonvolatile Memory Device And Method For Accessing Nonvolatile Memory Device

(75) Inventors: Masayuki Toyama, Osaka (JP); Tomoaki Izumi, Osaka (JP); Kazuaki Tamura, Osaka (JP); Kiminori Matsuno, Osaka (JP); Manabu Inoue, Osaka (JP); Masahiro Nakanishi, Kyoto (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/718,965

(22) PCT Filed: Nov. 8, 2005
(86) PCT No.: PCT/JP05/20444

§ 371 Date: May 9, 2007

(30) Foreign Application Priority Data
Nov. 10, 2004 (JP) 2004-326184

(51) Int. Cl. G06F 12/00

(52) U.S. Cl. 711/167; 711/E12.001

(57) ABSTRACT

The present invention provides a nonvolatile memory device that can be used in combination with a plurality of types of memory controllers that are different in number of banks to be simultaneously accessed, the nonvolatile memory device being also capable of achieving high-speed access.

The nonvolatile memory device of the present invention includes: a memory area divided into a plurality of banks from/to which data can be read/written independently; and data registers for storing data that has been read from the memory area or that is to be written to the memory area, the data registers being at least equal in number to the banks, and connections between the banks and the data registers are changed in accordance with the number of banks that are to be simultaneously accessed.

### TECHNICAL FIELD

The present invention relates to a nonvolatile memory device in which nonvolatile memory cells such as flash memory cells are used as memory elements, and a method for accessing the nonvolatile memory device.

### BACKGROUND ART

In recent years, memory devices using nonvolatile memory such as flash memory are widely used for holding digital information for use in digital cameras, movie players, portable music players, etc., and the amount of data that can be held in the memory devices is increasing. However, the flash memory requires significant time for erasing and writing, and therefore increasing the amount of data that is to be held results in a reduction in transfer rate. Thus, there is a need for a memory device capable of meeting both demands for a larger amount of data and a higher transfer rate.

In order to satisfy such a need, there has been proposed a system in which a flash memory is composed of a plurality of banks to/from which data can be written/read independently, and the banks are each provided with a data register, making it possible to perform so-called multi-page access for simultaneously accessing the banks, and thereby to achieve high-speed transfer (see Patent Document 1).

### Patent Document: Japanese Laid-Open Patent Publication No. 2001-266579

### DISCLOSURE OF THE INVENTION

### Problem To be Solved by the Invention

The performance of the above-mentioned conventional memory device can be enhanced by increasing the number of banks, but in order to do so, the memory device must be used in combination with a memory controller that supports multi-page access.

In order to achieve high-speed transfer in the conventional memory device, a memory controller capable of simultaneously accessing all the banks is required, but designing a new memory controller to accord with an increased number of banks leads to a cost increase.

On the other hand, it is also possible to use the memory device with an increased number of banks in combination with an existing memory controller designed for multi-page access to a small number of banks, but in such a case, Furthermore, in the case of accessing with such an existing memory controller, data registers provided in banks that are not involved in multi-page access are not used, and therefore they are wasted resources. As such, despite increase in area and cost, achieved performance is only at the same level as a memory device with a small number of banks.

Therefore, an object of the present invention is to provide a nonvolatile memory device capable of, when used in combination with a memory controller that supports multi-page access to all banks, achieving high-speed transfer, as well as capable of, even when used in combination with an existing memory controller that supports multi-page access to a small number of banks, enhancing transfer performance compared to conventional memory devices, and another object is to provide a method for accessing the same nonvolatile memory device.

### Means for Solving the Problem

To solve the above-mentioned problem, the present invention provides a nonvolatile memory device including:

a memory area divided into a plurality of banks from/to which data can be read/written independently;

a data register portion including data registers for storing data that has been read from the memory area or that is to be written to the memory area, the data registers being at least equal in number to the banks;

a control circuit for writing data stored in the data register portion to the memory area, or reading data from the memory area to store the read data to the data register portion, in accordance with an instruction from a memory controller; and

a data register selection portion for changing connections between the banks and the data registers in accordance with the number of banks that are to be simultaneously accessed.

In the nonvolatile memory device of the present invention, the data register selection portion preferably selects data registers that are to be used for accessing the banks in accordance with a command issued by the memory controller.

The data registers that are to be used for accessing the banks may be directly designated by the command. In addition, the data register selection portion may select the data registers that are to be used for accessing the banks, based on an argument of the command issued by the memory controller.

Also, in the nonvolatile memory device of the present invention, the data register selection portion may select data registers that are to be used for accessing the banks in accordance with a selection signal inputted from an external terminal. In addition, the data register selection portion may be operable to select a plurality of data registers for use in accessing one of the banks.

Furthermore, in the nonvolatile memory device of the present invention, the data register selection portion may select different data registers for use in writing data to any one of the banks and reading data from that bank.

The present invention also provides a method for accessing a nonvolatile memory device including:

a memory area divided into a plurality of banks from/to which data can be read/written independently; and data registers for storing data that has been read from the memory area or that is to be written to the memory area, the data registers being at least equal in number to the banks,

wherein connections between the banks and the data registers are changed in accordance with the number of banks that are to be simultaneously accessed.

In the access method of the present invention, it is preferred that at least two of the data registers are selected for any one of the banks that is to be accessed, and the separate data registers are used in parallel, one for storing data transferred from the memory controller, and one for writing data stored therein to the memory area.

Also, it is preferred that at least two of the data registers are selected for any one of the banks that is to be accessed, and the separate data registers are used in parallel, one for transferring data stored therein to the memory controller, and one for storing data that has been read from the memory area.

Also, in the access method of the present invention, predetermined data that has been read from any bank may be stored to one of the data registers, and transferred to the memory controller when an instruction to read the predetermined data is given by the memory controller, whereas when overwriting the predetermined data, the data stored in the data register may be updated with data transferred from the memory controller, and thereafter written to the bank.

Also, when any of the data registers is selected for accessing any one of the banks, any unselected data register may be used as a volatile memory area.

### Effect of the Invention

The nonvolatile memory device according to the present invention makes it possible to select data registers that are to be connected to banks, and therefore to enhance access speed in accordance with an access method used by the memory controller. In addition, it is possible for the memory controller to access any data registers that are not performing data transfer with their respective banks, and therefore data can be inputted/outputted in a pipelining manner, whereby it is possible to enhance access speed.

Furthermore, the data registers that are not performing data transfer with their respective banks can be used as volatile memory areas, and therefore it is possible to expand working memory for the memory controller without causing a cost increase, and thereby to enhance performance of the controller.

### BRIEF DESCRIPTION OF THE DRAWINGS

FIG. 1 is a block diagram of a nonvolatile memory device according to an embodiment of the present embodiment.

FIG. 2 is a conceptual diagram illustrating examples of connections between banks and data registers in the device.

FIG. 3 is a conceptual diagram for explaining a writing process for multi-page access to four banks in the device.

FIG. 4 is a conceptual diagram for explaining a writing process for multi-page access to two banks in the device.

FIG. 5 is a conceptual diagram for explaining a reading process for multi-page access to four banks in the device.

FIG. 6 is a conceptual diagram for explaining a reading process for multi-page access to two banks in the device.

FIG. 7A is a conceptual diagram for explaining (the first part of) a process in which different data registers are used for reading and writing in the device.

FIG. 7B is a conceptual diagram for explaining (the second part of) the process in which different data registers are used for reading and writing in the device.

FIG. 8 is a conceptual diagram for explaining a process in which data registers in the device are used as volatile working memory areas.

### BEST MODE FOR CARRYING OUT THE INVENTION

Hereinafter, a nonvolatile memory device according to an embodiment of the present invention will be described with reference to the drawings.

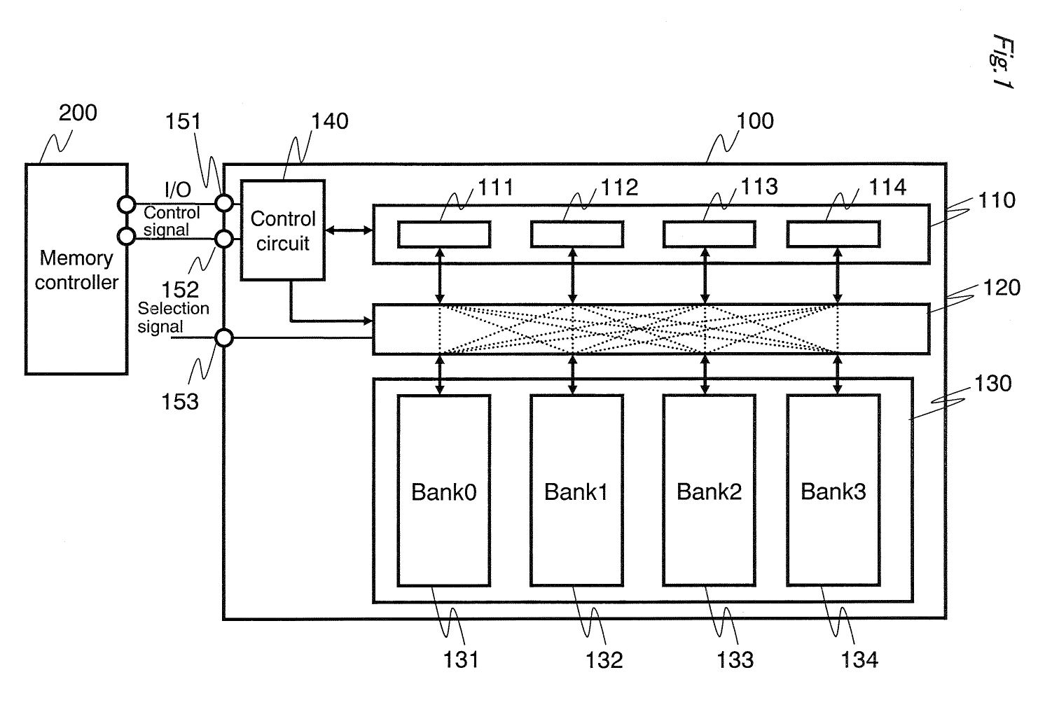

FIG. 1 is a block diagram illustrating a configuration of the nonvolatile memory device according to the present embodiment. In FIG. 1, 100 denotes the nonvolatile memory device from/to which data is read/written in accordance with a command sent from a memory controller 200.

The nonvolatile memory device 100 includes a data register portion 110, a data register selection portion 120, a memory area 130, and a control circuit 140. The memory area 130 is composed of nonvolatile memory cells such as flash memory cells, and divided into four banks 131 to 134 (Bank0 to Bank3) on which reading/writing can be performed independently. The data register portion 110 is composed of four data registers 111 to 114, which are used by the memory controller 200 for accessing the memory area 130. The data register selection portion 120 selects a data register that is to be used for accessing any of the banks 131 to 134.

The control circuit 140 writes data, which is transferred from the memory controller 200 via an I/O terminal 151, to the memory area 130 in accordance with a command and an address, which are transferred from the memory controller 200 via a control signal terminal 152, and the control circuit 140 also reads data from the memory area 130, and transfers it to the memory controller 200.

Control signals transferred from the memory controller 200 include CLE (COMMAND LATCH ENABLE) and ALE (ADDRESS LATCH ENABLE), which indicate the types of information inputted to the I/O terminal 151, a write signal WE (WRITE ENABLE), a read signal RE (READ ENABLE), and an R/B (READY/BUSY) signal, which is a state signal indicating the state of the memory area 130.

Note that in addition to the components as shown in the figure, the nonvolatile memory device 100 includes an address buffer, a sense amplifier, row/column decoders, etc., which are omitted because they are irrelevant to the description of the present invention.

In FIG. 1, the data register selection portion 120 changes connections between the banks 131 to 134 and the data registers 111 to 114. The data register selection portion 120 performs the changing in accordance with the number of banks that are to be accessed by multi-page access, which is designated by a command from the memory controller 200. In addition, the data register selection portion 120 may be instructed directly by a command from the memory controller 200, regarding the connections between the banks and the data registers.

Note that the designation or instruction is given by using a command, data, or a combination thereof. In the case of making the designation by a command, the command may be exclusively prepared for designating the number of banks, or an argument of the command may designate the number of banks.

The connections between the banks and the data registers may be changed in accordance with a selection signal inputted from an external terminal 153. The selection signal may designate the number of banks that are to be accessed by multi-page access or the connections between the banks and the data registers.

Next, the operation of the nonvolatile memory device 100 will be described, starting with the mode of multi-page access performed for reading/writing data to/from the nonvolatile memory device 100.

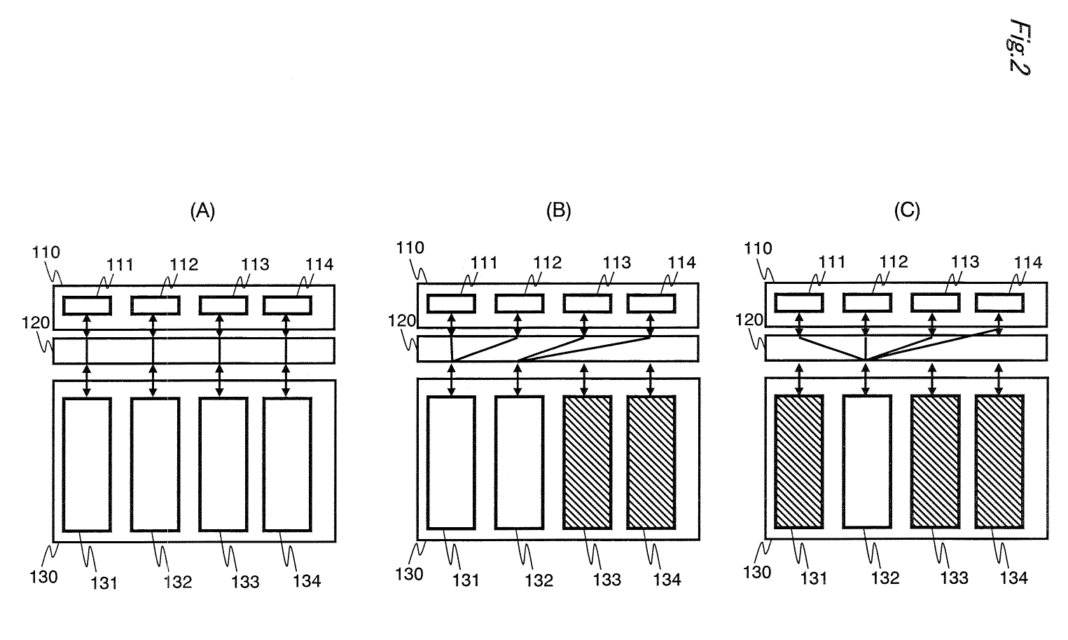

FIG. 2 illustrates the number of banks used in multi-page access and connections between the banks and data registers.

Part (A) of FIG. 2 shows an example of connections between banks and data registers in the case of multi-page access to four banks. The banks 131 to 134 are connected to the data registers 111 to 114, respectively.

Part (B) of FIG. 2 shows an example of connections between banks and data registers in the case of multi-page access to two banks 131 and 132. In the figure, the banks 131 and 132 are selected for access; the bank 131 is connected to the data registers 111 and 112, whereas the bank 132 is connected to the data registers 113 and 114. Note that the hatched banks 133 and 134 are handled as areas continued from the banks 131 and 132, respectively; when the banks 133 and 134 are selected, the data registers 111 and 112 are connected to the bank 133, whereas the data registers 113 and 114 are connected to the bank 134.

Part (C) of FIG. 2 shows an example of connections between banks and data registers in the case of single-page access to the bank 132. In the figure, the bank 132 is selected for access, and connected to the data registers 111 to 114. In the case of selecting any bank other than the bank 132, the selected bank is connected to all the data registers as in the case of the bank 132.

In the case of accessing to a small number of banks as shown in parts (B) and (C) of FIG. 2, the nonvolatile memory device of the present invention allows a plurality of data registers to connect to each bank, and therefore even in the case of using a memory controller that performs multi-page access only to a small number of banks, it is possible to perform high-speed data transfer by using a plurality of data registers.

Next, processing for writing/reading will be concretely described with reference to the drawings.

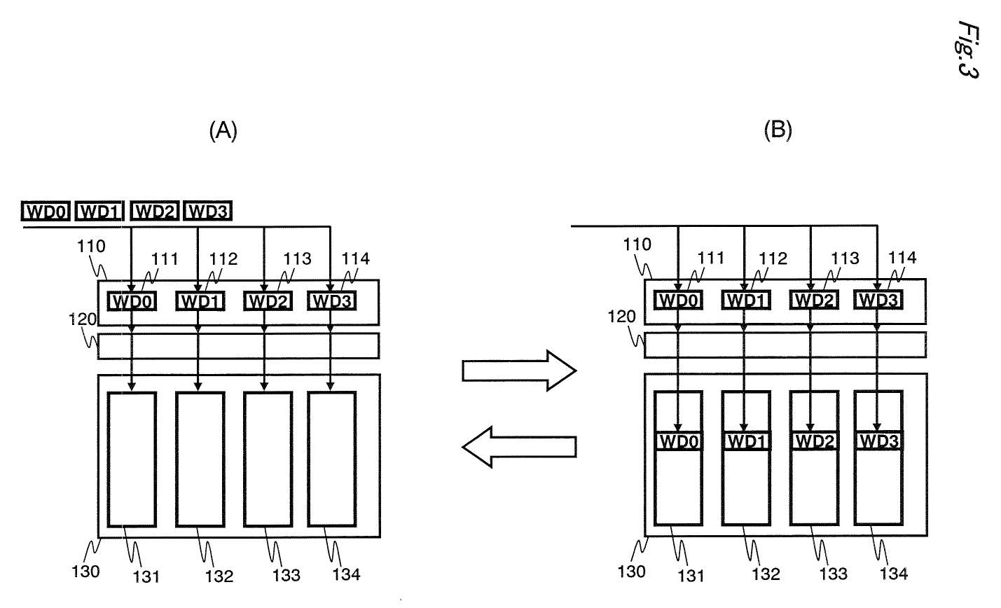

FIG. 3 illustrates data flows in the case of writing by multi-page access to four banks. The banks 131 to 134 are connected to the data registers 111 to 114, respectively. In part (A) of FIG. 3, data pieces WD0 to WD3 sent from the memory controller 200 are stored to the data registers 111 to 114, respectively, whereas in part (B) of the figure, the data pieces in the data registers 111 to 114 are written to their respective memory areas in the banks 131 to 134. After the data writing is completed, the procedure returns to part (A) of FIG. 3, where new data pieces sent from the memory controller are stored to the data registers 111 to 114. Thereafter, the processing in parts (A) and (B) of the figure will be repeatedly performed.

In this manner, by simultaneously writing data pieces to four banks, it is made possible to achieve high-speed writing.

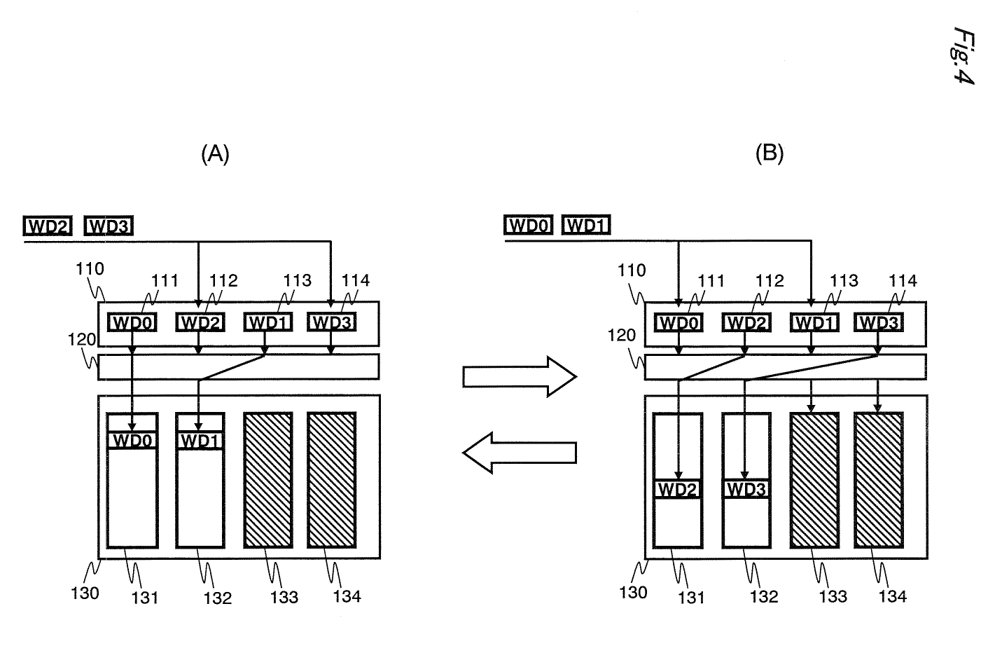

FIG. 4 illustrates data flows in the case of writing by multi-page access to two banks. In part (A) of FIG. 4, while data pieces WD0 and WD1, which have been written in the data registers 111 and 113, respectively, by the memory controller 200, are being written to the banks 131 and 132, respectively, data pieces WD2 and WD3 sent from the memory controller 200 are stored to the data registers 112 and 114, respectively. After the writing is completed, while the data pieces stored in the data registers 112 and 114 are being written to the banks 131 and 132, respectively, as shown in part (B) of the figure, new data pieces WD0 and WD1 sent from the memory controller 200 are stored to the data registers 111 and 113, respectively. Thereafter, the processing in parts (A) and (B) of the figure will be repeatedly performed.

In this manner, by writing data pieces in data registers to banks, in parallel with storing next data pieces to other data registers, it is made possible to achieve high-speed writing.

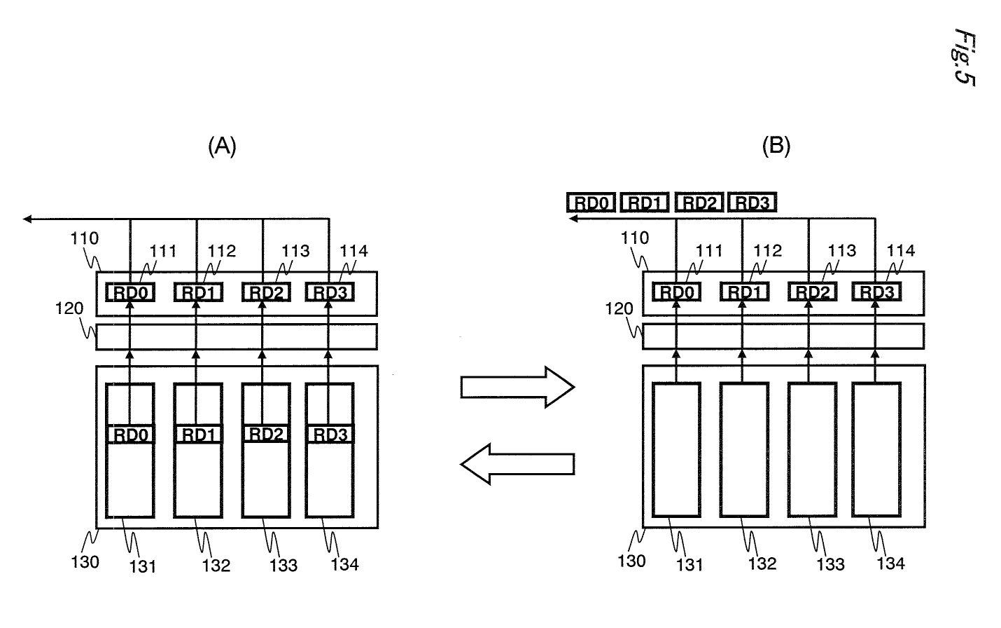

FIG. 5 illustrates data flows in the case of reading by multi-page access to four banks. In part (A) of FIG. 5, data pieces RD0 to RD3 in the banks 131 to 134 are stored to the data registers 111 to 114, respectively, whereas in part (B) of the figure, the stored data pieces RD0 to RD3 are outputted to the memory controller 200. After the data outputting is completed, the procedure returns to part (A) of FIG. 5, where next data pieces in the banks 131 to 134 are stored to the data registers 111 to 114, respectively. Thereafter, the processing in parts (A) and (B) of the figure will be repeatedly performed.

In this manner, by simultaneously reading data pieces in four banks, it is made possible to achieve high-speed reading.

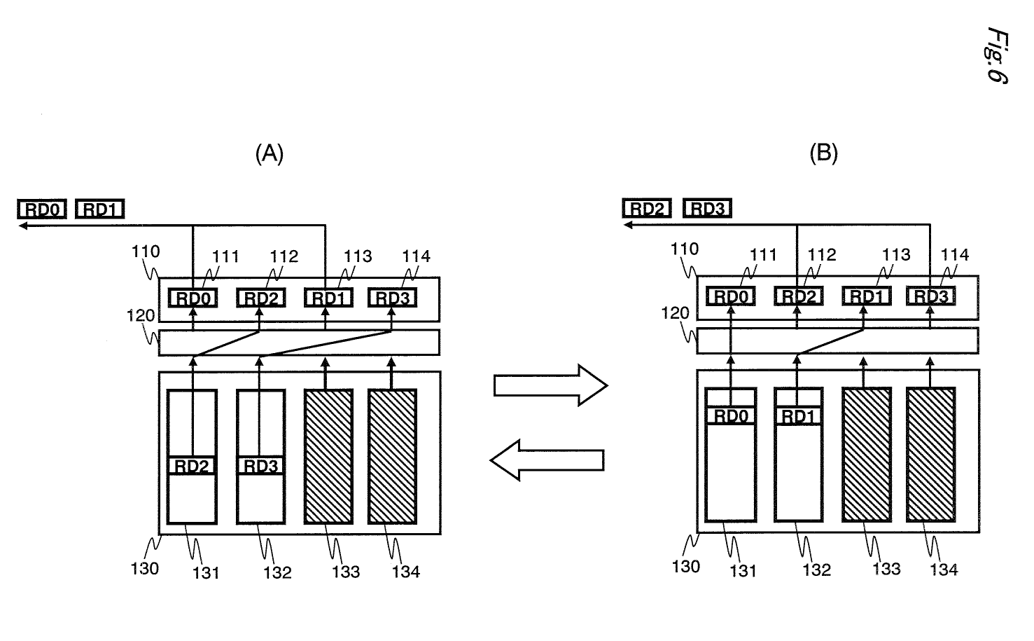

FIG. 6 illustrates data flows in the case of reading by multi-page access to two banks. In part (A) of FIG. 6, while data pieces RD0 and RD1, which have been read from the banks 131 and 132, respectively, and stored to the data registers 111 and 113, respectively, are being outputted to the memory controller 200, data pieces RD2 and RD3 in the banks 131 and 132 are read and stored to the data registers 112 and 114, respectively. After the transfer of the data pieces RD0 and RD1 and the storage of the data pieces RD2 and RD3 are completed, while the data pieces RD2 and RD3 stored in the data registers 112 and 114 are being transferred to the memory controller 200 as shown in part (B) of the figure, next data pieces RD0 and RD1 in the banks 131 and 132 are read and stored to the data registers 111 and 113, respectively. Thereafter, the processing in parts (A) and (B) of the figure will be repeatedly performed.

In this manner, by outputting data pieces in data registers to the memory controller, in parallel with storing next data pieces to other data registers, it is made possible to achieve high-speed reading.

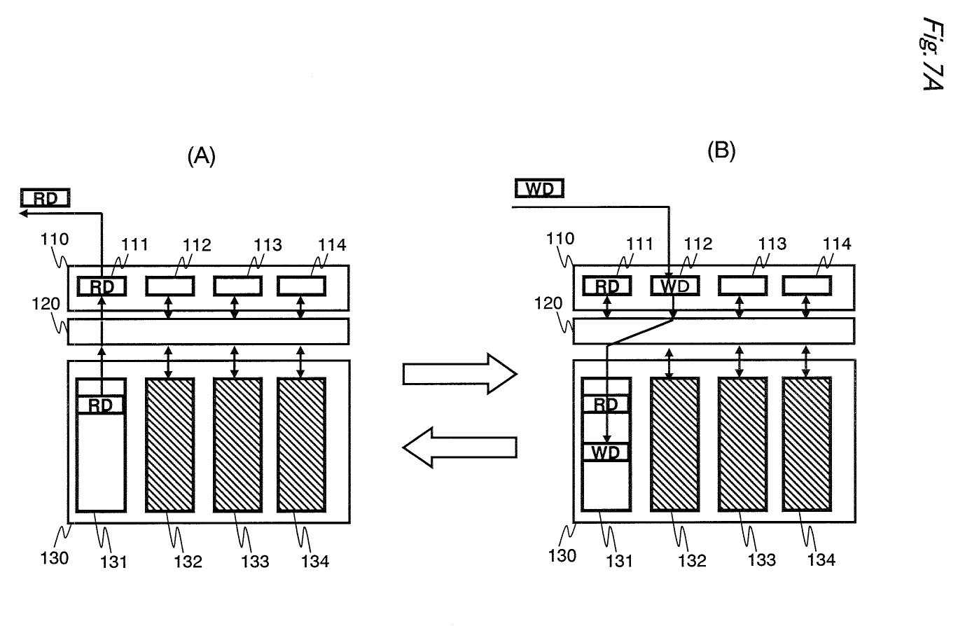

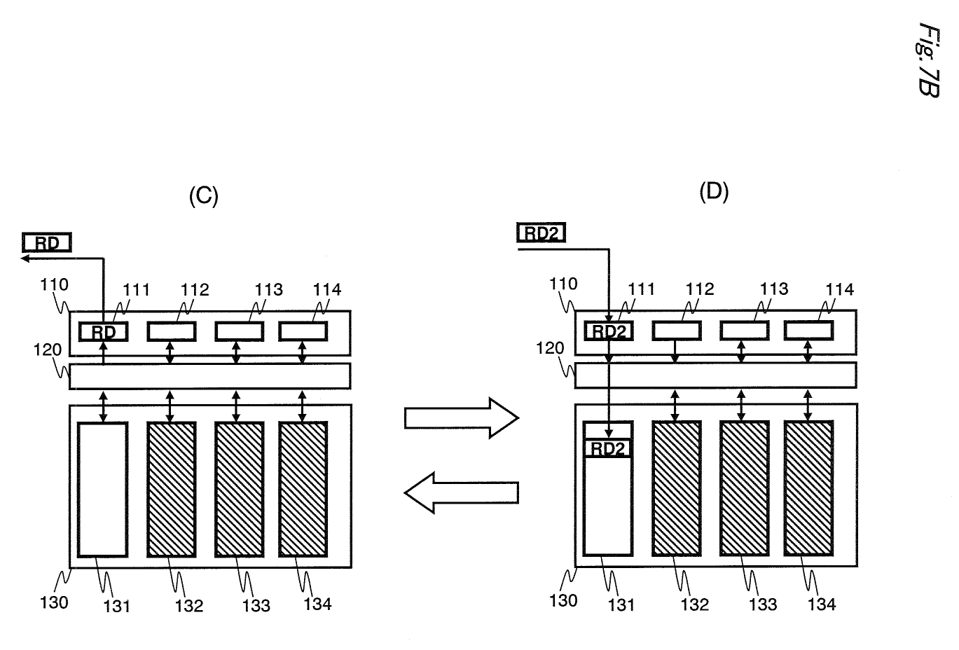

FIGS. 7A and 7B illustrate data flows in the case of using different data registers for reading from and writing to the same bank. In part (A) of FIG. 7A, a data piece RD in the bank 131 is read and stored to the data register 111, and then transferred to the memory controller 200. In this case, the data piece RD also remains in the data register 111.

Next, if a write request is given by the memory controller 200, a data piece WD transferred from the memory controller 200 is stored to the data register 112, and written to the bank 131 as shown in part (B) of FIG. 7A. If a request to read a data piece RD is given by the memory controller 200, the data piece RD stored in the data register 111 is transferred as shown in part (C) of FIG. 7B. Note that if a request to write an update data piece RD2 for the data piece RD is given by the memory controller 200, the data piece RD2 is stored to the data register 111 for data updating, and thereafter written to the bank 131 as shown in part (D) of FIG. 7B. Thereafter, the processing in parts (A) to (D) of FIGS. 7A and 7B will be performed in accordance with requests from the memory controller.

In this manner, by using different data registers for reading and writing, it is made possible to constantly hold in the data registers frequently-referenced data pieces such as management information concerning the nonvolatile memory, and thereby to achieve high-speed access.

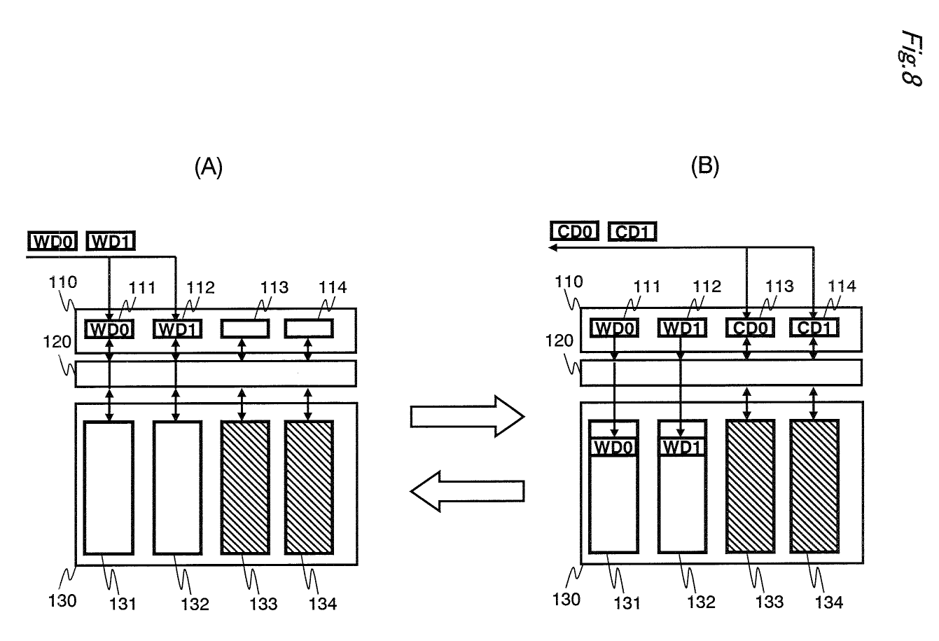

FIG. 8 illustrates data flows in the case of writing by multi-page access to two banks, with inactive data registers being used as volatile working memory areas for the memory controller 200. In part (A) of FIG. 8, write data pieces WD0 and WD1 transferred from the memory controller 200 are stored to the data registers 111 and 112, respectively. After the data storage is completed, the memory controller 200 reads data pieces CD0 and CD1 stored in the data registers 113 and 114, respectively, as shown in part (B) of FIG. 8, while the data pieces WD0 and WD1 are being written to the banks 131 and 132, respectively.

In this manner, by using data registers that are not used for accessing the memory area (in this case, the data registers 113 and 114) as working memory for the memory controller 200, it is made possible to extend the capacity of working memory for the memory controller 200 without causing a cost increase, and thereby to achieve enhancement in performance.

While the nonvolatile memory device according an embodiment of the present invention and the method for accessing the same have been described above, the applicable scope of the invention is not limited thereto, and similar effects can be achieved even if the number of banks on which multi-page access is performed is changed or the number of data registers exceeds the number of banks.

### INDUSTRIAL APPLICABILITY

The present invention makes it possible to provide a high-performance and easy-to-use nonvolatile memory device adaptable to access methods pertaining to memory controllers, and therefore is suitable for memory devices that require high-speed access.

1. A nonvolatile memory device comprising:
a memory area divided into a plurality of banks from/to which data can be read/written independently;
a data register portion including data registers for storing data that has been read from the memory area or that is to be written to the memory area, the data registers being at least equal in number to the banks;
a control circuit for writing data stored in the data register portion to the memory area, or reading data from the memory area to store the read data to the data register portion, in accordance with an instruction from a memory controller; and
a data register selection portion for changing connections between the banks and the data registers in accordance with the number of banks that are to be simultaneously accessed.

2. The nonvolatile memory device according to claim 1, wherein the data register selection portion selects data registers that are to be used for accessing the banks in accordance with a command issued by the memory controller.

3. The nonvolatile memory device according to claim 2, wherein the data registers that are to be used for accessing the banks are directly designated by the command.

4. The nonvolatile memory device according to claim 2, wherein the data register selection portion selects the data registers that are to be used for accessing the banks, based on an argument of the command issued by the memory controller.

5. The nonvolatile memory device according to claim 1, wherein the data register selection portion selects data registers that are to be used for accessing the banks in accordance with a selection signal inputted from an external terminal.

6. The nonvolatile memory device according to claim 1, wherein the data register selection portion is operable to select a plurality of data registers for use in accessing one of the banks.

7. The nonvolatile memory device according to claim 1, wherein the data register selection portion selects different data registers for use in writing data to any one of the banks and reading data from that bank.

8. A method for accessing a nonvolatile memory device including: a memory area divided into a plurality of banks from/to which data can be read/written independently; and data registers for storing data that has been read from the memory area or that is to be written to the memory area, the data registers being at least equal in number to the banks,
wherein connections between the banks and the data registers are changed in accordance with the number of banks that are to be simultaneously accessed.

9. The method for accessing the nonvolatile memory device according to claim 8, wherein at least two of the data registers are selected for any one of the banks that is to be accessed, and the separate data registers are used in parallel, one for storing data transferred from the memory controller, and one for writing data stored therein to the memory area.

10. The method for accessing the nonvolatile memory device according to claim 8, wherein at least two of the data registers are selected for any one of the banks that is to be accessed, and the separate data registers are used in parallel, one for transferring data stored therein to the memory controller, and one for storing data that has been read from the memory area.

11. The method for accessing the nonvolatile memory device according to claim 8, wherein different data registers are selected for use in writing data to any one of the banks and reading data from that bank.

12. The method for accessing the nonvolatile memory device according to claim 8, wherein predetermined data that has been read from any bank is stored to one of the data registers, and transferred to the memory controller when an instruction to read the predetermined data is given by the memory controller, whereas when overwriting the predetermined data, the data stored in the data register is updated with data transferred from the memory controller, and thereafter written to the bank.

13. The method for accessing the nonvolatile memory device according to claim 8, wherein when any of the data registers is selected for accessing any one of the banks, any unselected data register is used as a volatile memory area.
